(19) United States
(12) Patent Application Publication
(10) Pub. No.: US 2002/0101780 A1
(43) Pub. Date: Aug. 1, 2002

(54) Portable beverage delivery system

(76) Inventor: James J. Lloyd, Laguna Niguel, CA (US)

Correspondence Address: STETINA BRUNDA GARRED & BRUCKER, 75 ENTERPRISE, SUITE 250, ALISO VIEJO, CA, 92656, US

(21) Appl. No.: 10/109,524

(22) Filed: Mar. 28, 2002

Related U.S. Application Data
(63) Continuation of application No. 09/952,623, filed on Sep. 14, 2001.
Application No. 09/952,623 is a continuation of application No. 09/414,617, filed on Oct. 8, 1999, now abandoned.

(51) Int. Cl. B01F 3/08

(52) U.S. Cl. 366/130; 206/219; 206/427

(57) ABSTRACT

A portable beverage delivery system for preparing and delivering a multi-component beverage whose plurality of individual components can be maintained separately for subsequent combination to form the beverage. A first embodiment includes a housing with a mixing chamber disposed therein to form the final beverage product. The chamber has an introduction aperture and an exit aperture which are separate or are the same, and the housing has an opening through which the exit aperture is accessible and through which a mixed beverage can be dispensed. A second embodiment is a two chamber structure disposed within a housing and having a first chamber for containing a first beverage element, a second chamber for containing a second beverage element, and an exit aperture. The chambers are separated by a frangible wall whereby rupture thereof results in mixing of the first and second liquids of the multi-component beverage to form the beverage product which then can be dispensed through the exit aperture.

### CROSS-REFERENCE TO RELATED APPLICATIONS

(Not Applicable)

### STATEMENT RE: FEDERALLY SPONSORED RESEARCH/DEVELOPMENT

(Not Applicable)

### FIELD OF THE INVENTION

This invention relates in general to beverage packaging and dispensing, and in particular to a portable beverage delivery system wherein one component, non-limitedly exemplified as liquor, of a multi-component beverage, non-limitedly exemplified as a cocktail, can be maintained separately from one or more other components, non-limitedly exemplified as a carbonated mixer, for subsequent combination to form the multi-component beverage within the delivery system and provide dispenser-delivery therefrom upon call.

### BACKGROUND OF THE INVENTION

In general, beverages can be divided into single-component and multi-component products. Examples of the former include soft drinks such as various colas, soda, root beer, water, coffee, tea, wine, beer, etc., while examples of multi-component products include alcoholic drinks containing liquor and mixer such as bourbon and soda, scotch and water, rum and cola, etc. The latter products typically contain a relatively small amount of liquor and a relatively large amount of mixer.

Because governmental taxation of a packaged alcoholic product such as a bottle of liquor is based on the volume of the bottle as opposed to weight or concentration of liquor present, beverage producers cannot afford to sell pre-mixed cocktails since, even though a packaged cocktail container may contain only one ounce of liquor and seven ounces of mixer, taxation would be based on the total of eight, and not one, ounces of liquor. Consequently, a consumer is forced to inconveniently transport at least two separate containers (e.g. liquor and mixer) when taking refreshments to an outside function, and must thereafter locate accommodations that permit a proper mixing and serving procedure. Especially with outdoor functions, such accommodations many times are not available, thereby precluding availability of mixed-beverage products.

In view of the above hindrances, it is apparent that a need is present for convenient, yet equitably priced, packaging that allows carriage of separate components of a multi-component beverage, with subsequent integral mixing capabilities as part of the packaging for final production of a mixed-beverage product. In accord therewith, a primary object of the present invention is to provide a portable beverage delivery system for preparing and delivering a multi-component beverage through interaction of components separately maintained until final beverage production occurs.

Another object of the present invention is to provide a portable beverage delivery system that includes a mixing chamber into which separate beverage components can be introduced and mixed, and from which a resultant multi-component beverage can be controllably dispensed.

Yet another object of the present invention is to provide a portable beverage delivery system wherein a separately packaged container bearing one component of a final beverage product can be accommodated.

These and other objects of the present invention will become apparent throughout the description thereof which now follows.

### BRIEF SUMMARY OF THE INVENTION

The present invention is a portable beverage delivery system for preparing and delivering a multi-component beverage whose plurality of individual components can be maintained separately for subsequent combination to form the beverage. First embodiments comprise a housing with a mixing chamber disposed therein for mixing the individual components of the beverage to form the final beverage product. The chamber has a closeable introduction aperture thereto through which the individual components can enter the chamber, and a closeable exit aperture therefrom through which the beverage can be dispensed. Introduction and exit apertures can be separate from each other, or the exit aperture can be constructed to also function as an introduction aperture by permitting introduction of components into the chamber. A compartment is disposed within the housing for carrying a container such as a bottle bearing at least one of the individual components. The housing has an opening in substantial alignment with the exit aperture through which the exit aperture of the container is accessible and through which the beverage can be dispensed.

A second embodiment is a two chamber structure for preparing and delivering a multi-component beverage, and comprises a first chamber for containing a first liquid containing at least one component of the multi-component beverage and a second chamber for containing a second liquid containing at least one component of the multi-component beverage. The first and second chambers are separated by a frangible wall, and one chamber has a closeable exit aperture therefrom through which a final beverage product can be dispensed. Rupture of the frangible wall results in mixing of the first and second liquids of the multi-component beverage to form the beverage product which then can be dispensed through the exit aperture. The two-chamber structure can be disposed within a housing that has an opening in substantial alignment with the closeable exit aperture through which the exit aperture is accessible and through which the beverage can be dispensed.

Third embodiments comprise a housing with solely one mixing chamber disposed therein for receiving and mixing the individual components of the beverage as those components are introduced separately to form the final beverage product. Such component introduction can be through a dedicated introduction aperture or through the exit aperture which is constructed to also permit introduction of components into the chamber.

The portable delivery system here taught thus permits preparation and delivery of a multi-component beverage through interaction of components when desired, yet separately maintains these components until such final beverage production occurs. In this manner a singly-packaged system accomplishes convenient on-site generation of a multi-component beverage which otherwise may not practically be packageable or transportable.

### BRIEF DESCRIPTION OF THE DRAWINGS

Illustrative and presently preferred embodiments of the invention are shown in the accompanying drawings in which:

FIG. 1 is a perspective view of a first embodiment of a portable beverage delivery system;

FIG. 2 is a perspective view partially in section of the embodiment of FIG. 1;

FIG. 3 is a side elevation view of a cardboard housing blank of the embodiment of FIG. 1;

FIG. 4 is a perspective view of a second embodiment of a portable beverage delivery system;

FIG. 5 is a perspective view partially in section of the embodiment of FIG. 4;

FIG. 6 is a perspective view of a third embodiment of a portable beverage delivery system;

FIG. 7 is a perspective view partially in section of the embodiment of FIG. 6;

FIG. 8 is a perspective view of a fourth embodiment of a portable beverage delivery system; and

FIG. 9 is perspective view of a fifth embodiment of a portable beverage delivery system.

### DETAILED DESCRIPTION OF THE PREFERRED EMBODIMENTS

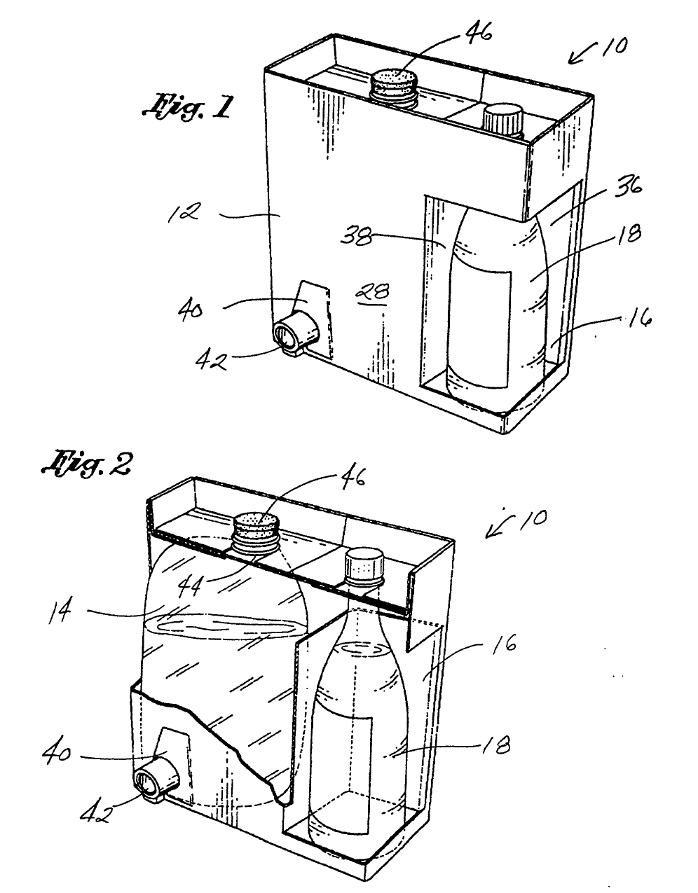

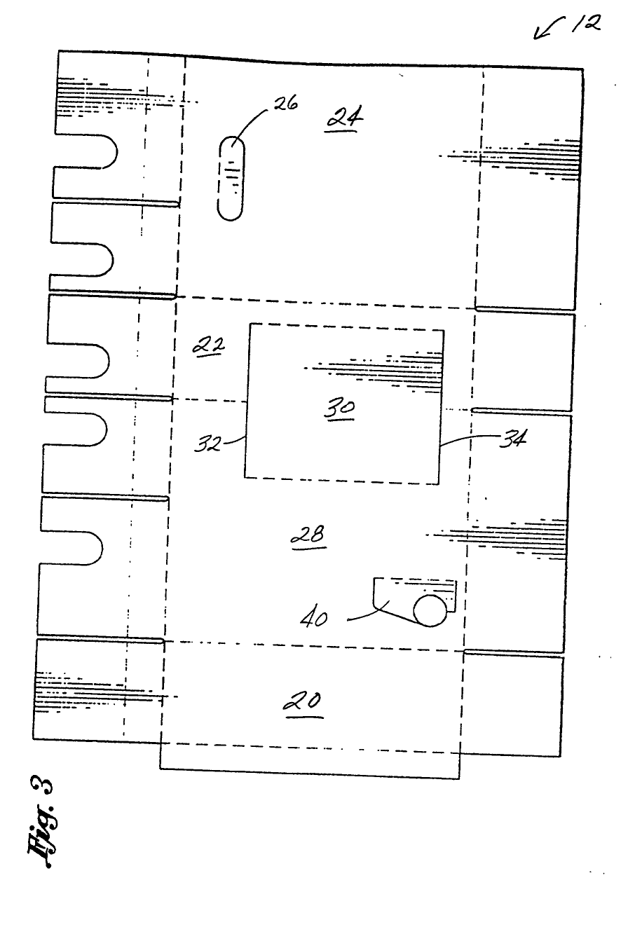

Referring first to FIGS. 1-3, a first embodiment of a portable beverage delivery system 10 is illustrated. The system 10 includes a cardboard housing 12, whose blank is shown in FIG. 3, for housing a preferably flexible-walled mixing chamber 14 and providing a compartment 16 within which a container such as a bottle 18 can be retained. As particularly shown in FIG. 3, the housing 12 has two opposing side panels 20, 22, a rear panel 24 with a cut-out 26 for hand-carry placement, and a front panel 28. A generally rectangular portion 30 of the front panel 28 and bridging equidistantly from the front panel 28 to the side panel 22 is cut along its top 32 and bottom 34 borders to thereby be foldable inwardly to provide the wall portions 36, 38 of the compartment 16 as shown in FIG. 1. The front panel 28 additionally has a spout cut-out 40 to accommodate placement of a spout 42 leading from the mixing chamber 14. The mixing chamber 14 is leak proof and can be constructed of a polymer such as polyethylene. A top opening 44 permits liquid introduction into the chamber 14 upon removal of a conventional friction-fit lid 46. A standard hand-operable valve spout 42 is situated near the bottom of the chamber 14 to allow controlled exit of liquid from the chamber 14.

In operation, a user of the first embodiment places a mixer-component liquid into the mixing chamber 14 through the opening 44 while maintaining a second liquid component such as liquor within the bottle 18 housed in the compartment 16. When two-component beverages are wanted, the user pours the liquid component from the bottle 18 into the mixing chamber 14 for blending with the already-present mixer component. Thereafter, the user dispenses the completed beverage through the spout 42 into a glass or other drinking container. If desired, the wall portions 36, 38 can be moved outwardly to thereby generally close the compartment 16, and ice or other source of cold can be placed in the compartment 16 to function as a refrigerant.

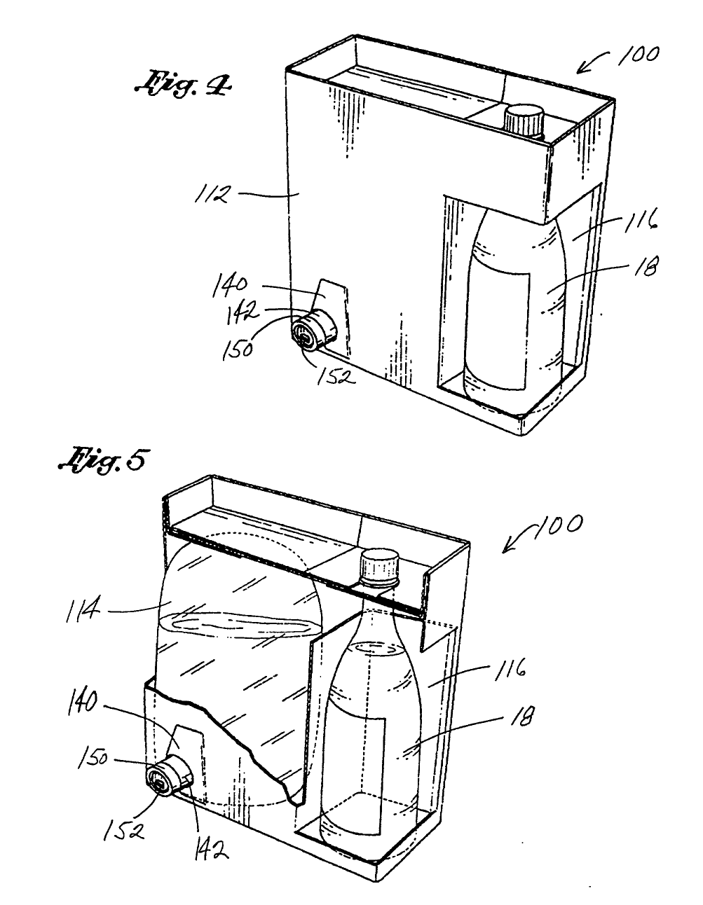

FIGS. 4 and 5 show a second embodiment of a beverage delivery system 100 that includes a cardboard housing 112 for housing a preferably flexible-walled mixing chamber 114 and providing a compartment 116, constructed in substantially the same manner as the compartment 16 of the embodiment of FIGS. 1-3, within which a container such as a bottle 18 can be retained. A spout cut-out 140 is provided in the housing 112 to accommodate a spout 142 provided to the mixing chamber 114. The spout 142 has a removable cover 150 in which is provided a hand operable valve 152 to thereby allow controlled passage of liquid from the chamber 114. In the same manner as the first embodiment earlier described, the mixing chamber 114 is leak proof and can be constructed of a polymer such as polyethylene.

In operation, a user of the second embodiment places a mixer-component liquid into the mixing chamber 114 through the spout 142 by removing the cover 150 from the spout 142 after turning the housing generally upside down. A second liquid component such as liquor is maintained within the bottle 18 housed in the compartment 116. When two-component beverages are wanted, the user pours the liquid component from the bottle 18 into the mixing chamber 114 likewise through the spout 142 by removing the cover 150 from the spout 142 after turning the housing generally upside down. Blending of the two liquids then occurs and the user dispenses the completed beverage through the spout 142 into a glass or other drinking container. If desired, the wall portions 136, 138 can be moved outwardly to thereby generally close the compartment 116 as in the first embodiment, and ice or other source of cold can be placed in the compartment 16 to function as a refrigerant.

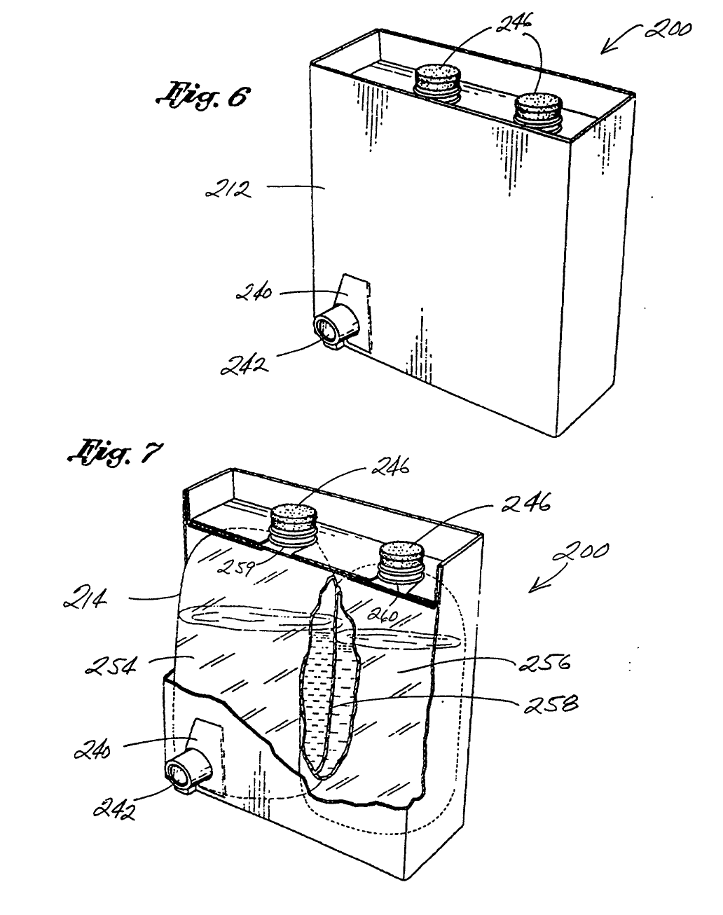

FIGS. 6 and 7 show a third embodiment of a beverage delivery system 200 that includes a cardboard housing 212 for housing a two-compartment flexible-walled mixing chamber 214 which is leak proof and can be constructed of a polymer such as polyethylene. As is illustrated, the mixing chamber 214 has two compartments 254, 256 separated from each other by a frangible wall 258 rupturable by application of hand pressure against the chamber 214. Each compartment 254, 256 has a respective top opening 259, 260 that permits liquid introduction into the compartments 254, 256 upon removal of respective conventional friction-fit lids 246. A single standard hand-operable valve spout 242 is situated near the bottom of the chamber 214 and is accommodated by a spout cut out 240 through the housing 212 to allow controlled exit of liquid.

In operation, a user of the third embodiment places a mixer-component liquid into one compartment 254 and a second liquid component such as liquor into the other compartment 256. When two-component beverages are wanted, the user applies a squeezing hand pressure upon the chamber 214 to thereby rupture the frangible wall 258 and accomplish blending of the liquids. Thereafter, the user dispenses the completed beverage through the spout 242 into a glass or other drinking container.

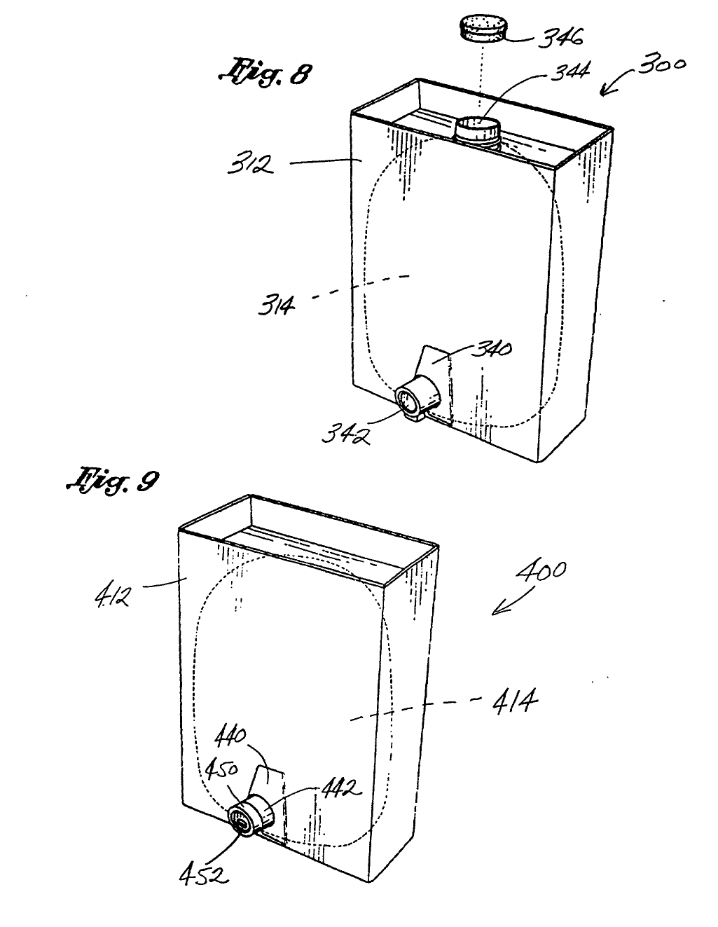

FIG. 8 shows a fourth embodiment of a beverage delivery system 300 that includes a cardboard housing 312 for housing a flexible-walled mixing chamber 314. The mixing chamber 314 is leak proof and can be constructed of a polymer such as polyethylene. A top opening 344 permits liquid introduction into the chamber 314 upon removal of a conventional friction-fit lid 346. A standard hand-operable valve spout 342 is situated near the bottom of the chamber 314 and is accommodated by a spout cut out 340 through the housing 312 to allow controlled exit of liquid.to allow controlled exit of liquid from the chamber 314.

In operation, a user of the fourth embodiment introduces all components of a desired beverage into the chamber 314 through the opening 344. Thereafter, the user dispenses the completed beverage through the spout 342 into a glass or other drinking container.

FIG. 9 shows a fifth embodiment of a beverage delivery system 400 that includes a cardboard housing 412 for housing a flexible-walled mixing chamber 414. The mixing chamber 414 is leak proof and can be constructed of a polymer such as polyethylene. A spout 442, accommodated by a spout cut out 440 through the housing 412, leads from the chamber 414 and has a removable cover 450 in which is provided a hand operable valve 452 to thereby allow controlled passage of liquid.

In operation, a user of the fifth embodiment introduces all components of a desired beverage into the chamber 414 through the spout 442 by removing the cover 450 from the spout 442 after turning the housing generally upside down. The cover 450 is replaced, and the user dispenses the completed beverage through the spout 442 into a glass or other drinking container.

As is thus apparent, the portable delivery system embodiments here taught permit preparation and delivery of a multi-component beverage through convenient on-site generation of a multi-component beverage which otherwise may not practically be packageable or transportable. While illustrative and presently preferred embodiments of the invention has been described in detail herein, it is to be understood that the inventive concepts may be otherwise variously embodied and employed and that the appended claims are intended to be construed to include such variations except insofar as limited by the prior art.

What is claimed is:

1. A portable beverage delivery system for preparing and delivering a multi-component beverage whose plurality of individual components can be maintained separately for subsequent combination to form the beverage, the delivery system comprising:
a) a housing;
b) a mixing chamber disposed within the housing, said mixing chamber for mixing therein the individual components of the beverage and thereby form the beverage, said chamber having a closeable introduction aperture thereto through which the individual components can enter the chamber and a closeable exit aperture therefrom through which the beverage can be dispensed; and
c) a compartment disposed within the housing, said compartment for carrying a container for bearing at least one of the individual components.

2. A portable beverage delivery system as claimed in claim 1 wherein the housing is constructed of cardboard.

3. A portable beverage delivery system as claimed in claim 2 wherein the compartment for carrying a container comprises as a portion thereof an upper border structure and a lower border structure for retaining respectively a top portion and a bottom portion of the container and between which is a void for permitting display of the container.

4. A portable beverage delivery system as claimed in claim 3 wherein an inside wall of the compartment is outwardly foldable to fill the void.

5. A portable beverage delivery system as claimed in claim 1 wherein the housing has an opening in substantial alignment with the exit aperture through which the exit aperture of the container is accessible and through which the beverage can be dispensed.

6. A portable beverage delivery system as claimed in claim 1 wherein the exit aperture is openable and closeable by hand operation of a valve integral with the exit aperture.

7. A portable beverage delivery system as claimed in claim 1 wherein the mixing chamber is a flexible plastic bag structure.

8. A portable beverage delivery system as claimed in claim 1 wherein the introduction aperture of the mixing chamber is disposed at an upper location thereof and the exit aperture thereof is disposed at a lower location thereof whereby gravity can enhance beverage flow through the exit aperture.

9. A portable beverage delivery system as claimed in claim 1 wherein the introduction aperture and the exit aperture are a single aperture.

10. A two chamber structure for preparing and delivering a multi-component beverage, the structure comprising a first chamber for containing a first liquid containing at least one component of the multi-component beverage and a second chamber for containing a second liquid containing at least one component of the multi-component beverage, wherein the first and second chambers are separated by a frangible wall and wherein one chamber has a closeable exit aperture therefrom through which the beverage can be dispensed, whereby rupture of the frangible wall results in mixing of the first and second liquids of the multi-component beverage to form the beverage for dispensing through the exit aperture.

11. A two chamber structure as claimed in claim 10 wherein the exit aperture thereof is disposed at a lower location thereof whereby gravity can enhance beverage flow through the exit aperture.

12. A two chamber structure as claimed in claim 10 wherein each chamber has a respective closeable introduction aperture thereto through which the first and second liquids can enter the respective first and second chambers.

13. A two chamber structure as claimed in claim 10 wherein the structure is a flexible plastic bag structure.

14. A portable beverage delivery system for preparing and delivering a multi-component beverage, the delivery system comprising:
a) a two chamber structure for preparing and delivering a multi-component beverage, the structure comprising a first chamber for containing a first liquid containing at least one component of the multi-component beverage and a second chamber for containing a second liquid containing at least one component of the multi-component beverage, wherein the first and second chambers are separated by a frangible wall and wherein one chamber has a closeable exit aperture therefrom through which the beverage can be dispensed, whereby rupture of the frangible wall mixes the first and second liquids of the multi-component beverage to form the beverage for dispensing through the exit aperture; and
b) a housing within which the two chamber structure is disposed, said housing having an opening in substantial alignment with the closeable exit aperture through which the exit aperture is accessible and through which the beverage can be dispensed.

15. A portable beverage delivery system as claimed in claim 14 wherein the housing is constructed of cardboard.

16. A portable beverage delivery system as claimed in claim 14 wherein the exit aperture of the two chamber structure is disposed at a lower location thereof whereby gravity can enhance beverage flow through the exit aperture.

17. A portable beverage delivery system as claimed in claim 14 wherein each chamber of the two chamber structure has a respective closeable introduction aperture thereto through which the first and second liquids can enter the respective first and second chambers.

18. A portable beverage delivery system as claimed in claim 14 wherein the two chamber structure is a flexible plastic bag structure.

19. A portable beverage delivery system for accepting, retaining, and delivering a beverage, the delivery system comprising:
a) a container having a closeable introduction aperture thereto through which liquid can enter and a closeable exit aperture therefrom through which liquid can be dispensed, said exit aperture openable and closeable by hand operation of a valve integral with the exit aperture; and
b) a housing within which the container is disposed, said housing having an opening in substantial alignment with the closeable exit aperture through which the exit aperture is accessible and through which liquid can be dispensed.

20. A portable beverage delivery system as claimed in claim 19 wherein the housing is constructed of cardboard.

21. A portable beverage delivery system as claimed in claim 19 wherein the introduction aperture of the container is disposed at an upper location thereof and the exit aperture thereof is disposed at a lower location thereof whereby gravity can enhance liquid flow through the exit aperture.

22. A portable beverage delivery system as claimed in claim 19 wherein the container is a flexible plastic bag structure.

23. A portable beverage delivery system as claimed in claim 19 wherein the introduction aperture and the exit aperture are a single aperture.
